(19) United States
(12) Patent Application Publication
(10) Pub. No.: US 2015/0358657 A1
(43) Pub. Date: Dec. 10, 2015

(54) BROADCAST CONDITIONAL ACCESS SYSTEM WITH IMPULSE PURCHASE CAPABILITY IN A TWO-WAY NETWORK

(71) Applicant: THOMSON LICENSING, Issy de Moulineaux (FR)

(72) Inventor: David Jay DUFFIELD, Indianapolis, IN (US)

(21) Appl. No.: 14/828,025

(22) Filed: Aug. 17, 2015

Related U.S. Application Data
(63) Continuation of application No. 10/580,806, filed on May 25, 2006, now abandoned.

(51) Int. Cl. H04N 21/2543; H04N 21/222; H04N 21/4623; H04N 21/438; H04N 21/4627; H04N 21/254; H04N 21/266

(52) U.S. Cl. CPC H04N 21/2543; H04N 21/2541; H04N 21/2221; H04N 21/26606; H04N 21/4382; H04N 21/4627; H04N 21/4623

(57) ABSTRACT

The invention relates generally to an apparatus and a method for securing impulse program purchases from conditional access network broadcast systems. The invention include providing entitlement codes to a set top boxe having security modules, located at a customer's corresponding program listening and viewing system. A customer desiring to makes an impulse purchase communicates the request to a broadcast system. In one embodiment of the invention, a message from the customer's access device transmits to a broadcast system's headend to indicate the desired purchase. In response to receiving an impulse purchase signal, the headend creates and sends an authorization code that thereafter authorizes the set top box to decode the impulse purchased program when it is received. The authorization code for a given impulse purchased program is only transmitted to set top boxes that actually purchase the program in contrast to the prior art system, where the decryption codes for impulse purchases are pre loaded into the security module before the event is purchased. The invention also generates data required for a billing record and transmits this data to a billing center.

### BACKGROUND OF THE INVENTION

1. Field of the Invention

The invention relates generally to a method and an apparatus for a multi-channel video programming distributor (MVPD) system that provides conditional access multimedia programming.

2. Description of Related Art

A subscriber broadcast system includes in part, a headend from which service provider programs are broadcast and step top boxes for receiving the selected programs, for the ultimate purpose of listening to and viewing the programs. Typically events are broadcast and thereafter viewed on the basis of a monthly subscription, a pay-per-view broadcast program and in certain instances, an impulse purchase where the customer decides to watch a program in close proximity to the time the program is broadcast. Current impulse purchase systems store, in advance of purchases, access keys in a security module located in the Set top box that can decode all of the services a customer may desire to purchase. If a customer makes a purchase, the security module stores a record of the purchase, and uses the key it had previously acquired, often at the beginning of a monthly subscription, to allow the customer to view the program being requested. Later, the security module creates a two-way communication channel with a billing center and transmits the billing information back to the service provider.

The prior art shown in FIG. 1 illustrates a typical conditional access system utilizing a headend and a set top box. U.S. Pat. No. 6,510,519, also provides a full description of a typical conditional access system. The set top box generally includes tuners, de-modulators, decoders, transport de-multiplexers, microprocessors, program memories, video picture memories, MPEG video decoders, displays, and smart cards. Most digital broadcast system data streams are encoded or scrambled for security purposes. The subscriber receives an entitlement control message which includes control words, which the set top box is required to decrypt, so as to form a descrambling key that permits the encoded audio and video signals to be assembled for consumption. The decryption control words are processed by algorithms programmed into the customer's set top box. Typically a 56-bit descrambling key is then stored in transport registers for further data decryption and descrambling. Once descrambling occurs, the system builds a video composite picture in memory, typically in accordance with the MPEG-2 standard, and displays the desired picture on a display. In addition to descrambling the program, generally, further authorizations are provided to insure that the particular set top box has been enabled to receive a program or a set of programs.

Authorization to view certain programs may be transmitted with the program or via a separate communications channel, as for example, an out-of-band RF link, to the set top box. For example, authorization information may include a key for the service and an indication of what

programs in the service the subscriber is entitled to listen to and watch. If the authorization information indicates that the subscriber is entitled to watch the program, then a control word generator uses the decryption key together with transmitted information to generate a control word.

When a subscription purchase for programming occurs the service provider transmits to the set top box belonging to the subscriber an authorization code, so as to perform subsequent decryption as required. This data, which constitutes the authorization information, is stored in a security module.

Various techniques are employed to scramble program content and the associated entitlement management messages. However, existing broadcast systems do not rely on a two-way communications channel from the customer equipment, typically a set to box, to the broadcast headend for impulse purchase authorization codes. This lack of two-way communications provides weaknesses such that a hacker has an opportunity to steal programs. Current impulse purchase systems store decryption keys in the customer's set top box's security modules that subsequently decode services a customer may potentially purchase. If a customer makes one of the purchases that have been preprogrammed into the security module, the security module typically stores a record of the purchase and uses the decryption key it already possesses to allow the customer to view the subject material purchased. At a later time, the security module may be configured to create a two-way communication channel with a billing center and thereby may transmit the billing information back to the service provider. If a hacker can divert the signal from the security module and decode the decryption keys, the hacker can potentially obtain programs and other services without paying. Also, if a hacker can purchase a program, but clear the purchase record before it is transmitted to the billing point, the user can avoid paying, as well.

### SUMMARY OF THE INVENTION

A secured network includes an entitlement management message (EMM) generator located in the headend that is used to provide program codes to a distribution of set top boxes having security modules located where the associated customer audio and viewing system is situated. When a customer makes an impulse purchase, the customer communicates the selection, as in the preferred embodiment, to a set top box, which causes a message to be transmitted to a headend indicating a desired purchase. In response to receiving an impulse purchase signal, the headend creates a message, such as an EMM that sends a decryption code that thereafter authorizes the set top box to decode the impulse purchased program when it is received. In response to the order being placed, the headend also generates a billing record and transmits the billing record to a billing center. The authorization codes for a given impulse purchased program are only transmitted to set top boxes that actually purchase the program, in contrast to the prior art systems, where the authorization codes for impulse purchases are pre loaded into the security module before the event is purchased.

The invention disclosed herein relates to an access device comprising: a means for receiving an impulse program; a means for indicating a desired impulse purchase; a means for communicating the desired impulse purchase; a means for receiving an authorization responsive to message that indicates the impulse purchase, and storing the authorization codes specific to the purchased program. The invention also generates data required for a billing record and transmits this data to a billing center.

The invention disclosed herein includes a method of providing an impulse purchaser a secure means for purchasing an program comprising the steps of: making an impulse purchase utilizing a means for receiving a program; transmitting a message that indicates the desired purchase, from a security means located in the means for receiving a program, to a headend means for controlling the transmission and reception of data utilized in the provision of the program through an entitlement management message; generating a billing record; addressing a decryption means specific to the purchased program; and finally, transmitting the decryption means to the device, where a security module is located.

### BRIEF DESCRIPTION OF THE DRAWINGS

The invention is best understood from the following detailed description when read in connection with the accompanying drawing. The various features of the drawings are not exhaustively specified. On the contrary, the various features may arbitrarily be expanded or reduced for clarity. Included in the drawing are the following figures:

FIG. 1 is a block diagram of a prior art of a conditional access system.

FIG. 2 is a block diagram of the invention for securing an impulse purchase program.

FIG. 3 is method of securing an impulse purchase program.

### DETAILED DESCRIPTION OF THE INVENTION

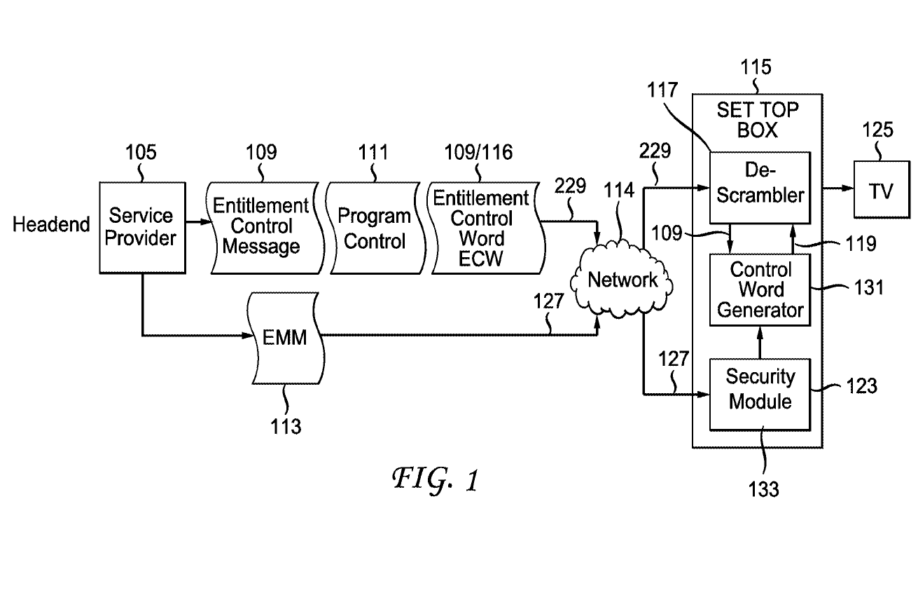

The prior art shown in FIG. 1 provides an overview of a service provider 105 system that supplies multimedia programming. Most digital broadcast system data streams are encrypted or scrambled for security purposes, that is to insure only authorized subscribers can view the programs transmitted.

In a subscriber based digital broadcast system, the customer receives an entitlement management message (EMM), which contains information necessary to generate the control word necessary to permit the descrambling and assembling of the digital video and audio data. The decryption control words are processed by algorithms programmed in a set top box 115 (typically in a smart card), which generate an N-bit descrambling key. Current systems typically utilize keys as large as 56-bits. The 56-bit keys are then stored in transport registers for further data descrambling of the program. Once descrambling occurs, the system builds a video composite picture in memory, typically in accordance with the MPEG-2 standard, and displays the desired picture on a display.

Digital broadcast system encoding is achieved by transmitting and receiving an entitlement control word 116 as a packet that contains decryption specifications in the form of input data. When the service provider broadcasts a program, it scrambles the program content 111.

The set-top box 115 determines whether scrambled program 111 should be descrambled. If it is determined based upon authorization codes that the program is one that the customer has purchased, then the set top box 115 proceeds to descramble the program and make it available for viewing. The set top box 115, includes a descrambler 117, which uses a control word 119 as a key to descramble scrambled programs 111. Control word 119 is produced by control word generator 131 from information contained in entitlement control message 109 and information from authorization information 123 stored in set-top box 115.

For example, authorization information 123 may include a key for the service and an indication of what programs in the service the subscriber is entitled to watch. If the authorization information 123 indicates that the subscriber is entitled to watch the scrambled program 111, control word generator 131 uses the decryption key together with information from ECM 109 to generate control word 119. A new control word 119 is generated for each new ECM 109.

The authorization information used in a particular set top box 115 is obtained from one or more EMMs 113 addressed to set top box 115. When a purchase for programs occurs the service provider transmits to the set top box 115, belonging to the subscriber, EMM 113 as to authorize 123 the descrambling, as required. Additionally, entitlement management messages, EMM, 113 are transmitted in a form that may be interleaved with the program 111 or they may be transmitted through a separate channel 127, to the set top box 115, which stores the information from the entitlement management message EMM 113 in a security module 133 containing authorization information 123.

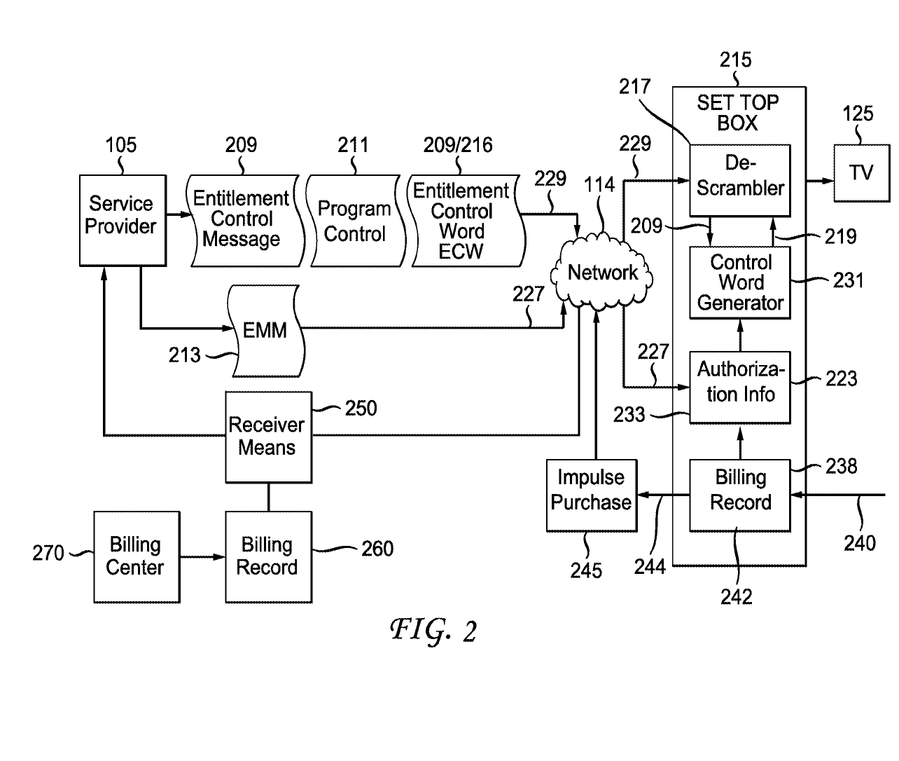

Referring to FIG. 2, the invention disclosed herein relates to an access device comprising: a means for receiving a program 215; a means for indicating a desired impulse purchase 240; a means for communicating the desired impulse purchase 245; a means 213 for transmitting to the set top box a code that permits the desired impulse purchase to be viewed. The system also may contain a means to generate billing record data 238 and transmits such data to a means for generating a billing record 260.

More specifically, when the service provider broadcasts a program, it scrambles the content 211. The set top box provides a means for receiving a transmission of the impulse purchase, including its reception in scrambled form, descrambling and providing a digital signal that can be viewed and listened to by a customer. More particularly, scrambled program content 211 contains video and audio data as well as various control messages such as ECM 209. Entitlement control messages 209 contain control words 216 that serve as descrambling codes so that the scrambled portion of the program 211, to which it pertains, can be descrambled and thereafter assembled in a manner that is viewable by the customer upon reception.

The set top box 215 decodes the protected digital data streams 229 that include broadcast programs as hereinbefore mentioned. The set-top box 215 determines whether scrambled program 211 should be descrambled. If it is determined based upon authorization codes that the program is one that the customer has purchased, then the set top box 215 proceeds to descramble the program and make it available for viewing. The set top box 215, includes a descrambler 217, which uses a control word 219 as a key to descramble scrambled programs 211. Control word 219 is produced by control word generator 231 from information contained in entitlement control message 209 and information from authorization information 223 stored in set-top box 215.

The scrambled data and ECM 209 associated with control word 216 are then received by a receiver 215 having means (typically on a smart card that is inserted into the receiver) to generate a control word 216 representing an N-bit descrambling key to decode the transmitted digital data.

As indicated in the prior art description, authorization information 223 may include a key for the service and an indication of what programs within the service the subscriber is entitled to view. If the authorization information 223 indicates that the subscriber is entitled to watch the program of scrambled program 211, control word generator 231 uses the decryption key together with information from ECM 209 to generate control word 219. The invention herein differs from the prior art in that the authorization information is not preloaded in the set top box 215, but is dependant upon the request for a desired impulse purchase and the responsive means for communicating the desired impulse purchase 245.

In the prior art, the authorization information is transmitted long in advance of any selected impulse program (“preloaded”). In the invention disclosed herein, upon receipt of a desired impulse purchase 240, as communicated through a transmitter means 245 and receiver means 250, the headend responds by transmitting authorization information 227 to a security module 233, where authorization information is stored in a memory 223. One means of communicating the authorization information 227 is through EMM 213, which may be transmitted in a form that is interleaved with the program 211 or alternatively transmitted through a separate channel 227, for example utilizing an out-of-band frequency or a communications network to the set top box 215, which stores the information from the entitlement management message EMM 213 in the memory 223 of the security module 233.

The apparatus for communicating and receiving programming disclosed herein includes a means to generate a billing record 260. Additionally, the bill is ultimately transmitted through a two-way communication channel to a billing center 270.

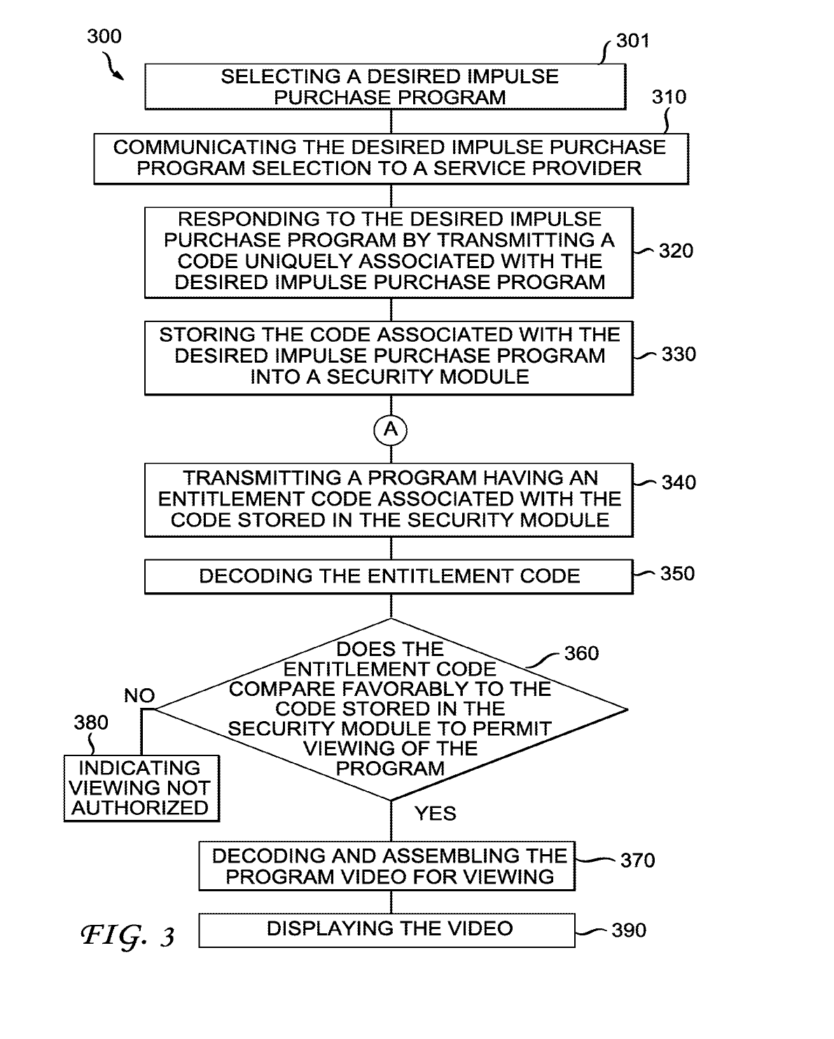

Referring to FIG. 3, the method of providing an impulse purchaser a secure means for purchasing a program includes selecting a desired impulse purchase program 301, communicating the desired impulse purchase program selection to a service provider 310, responding to the desired impulse purchase program by transmitting a code uniquely associated

with the desired impulse purchase program and a given receiver 320, storing the code associated with the desired impulse purchase program into a security module 330; transmitting a program having an entitlement code associated with the code stored in the security module 340; decoding the entitlement code 350; if the entitlement code does not compare favorably to the code stored in the security module to permit viewing of the program 360; indicating that viewing is not authorized 380; and if the entitlement code does compare favorably, decoding and assembling the program video for viewing 370; and displaying the video 390.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

What is claimed is:

1. An access device comprising:
a means for communicating an impulse purchase selection;
a means for receiving an authorization key responsive to the impulse purchase selection;
a means for receiving a transmission of the impulse purchase.

2. An access device comprising:
a means for indicating a desired impulse purchase selection;
a means for communicating the desired impulse purchase selection;
a means for receiving an authorization key specific to the desired impulse purchased program;
a means for receiving the transmission of the desired impulse purchase.

3. The access device in claim 2, wherein the means for receiving a transmission is a set top box.

4. The access device in claim 2, wherein the means for receiving the authorization key includes a security module.

5. The access device in claim 2, wherein the means for communicating the desired impulse purchase is a set top box.

6. An access device comprising:
a tuning and a decoding unit for transmitting an impulse purchase message and in response thereto, receiving an authorization key associated with the impulse purchase program;
a programmed means responsive to the authorization key that formats a digital program into a video display.

7. An access device comprising:
a tuning and a decoding unit for receiving an impulse purchase message;
a means to receive an authorization means associated with the impulse purchase program;
a means to generate billing data.

8. A method of providing a secure means for purchasing an impulse purchase program comprising the steps of:
communicating a message to a service provider means that indicates an impulse purchase selection;
generating billing data;
receiving an authorization means specific to the impulse purchase program;
receiving the impulse purchase program;
displaying a program responsive to the authorization means.

9. A method of providing a secure means for purchasing an impulse purchase program comprising the steps of:
making the impulse purchase utilizing a means for receiving a program;
communicating a message that indicates the purchase to a means for the reception of data utilized in the provision of the impulse purchase program;
receiving an authorization responsive to message that indicates the impulse purchase;
receiving a program responsive to the authorization specific to the impulse purchase program.

10. The method of claim 9, further comprising the step of generating a billing record.

11. A method of providing a secure means for purchasing an impulse purchase program comprising the steps of:
selecting the desired impulse purchase program;
communicating the desired impulse purchase program selection to a service provider;
responding to the desired impulse purchase program by transmitting an authorization code uniquely associated with the desired impulse purchase program;
storing the authorization code associated with the desired impulse purchase program into a security module;
transmitting an impulse purchase program having an entitlement code associated with authorization code stored in the security module;
decoding the entitlement code;
comparing the entitlement code to the code stored in the security module to permit viewing of the impulse purchase program.
